(19) United States
(12) Patent Application Publication
(10) Pub. No.: US 2002/0057811 A1
(43) Pub. Date: May 16, 2002

(54) APPARATUS USING COOLING SPACES AS SPEAKER CHAMBERS

(76) Inventors: WINSLOW SCOTT BURLESON, PALO ALTO, CA (US); EDWIN JOSEPH SELKER, PALO ALTO, CA (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(21) Appl. No.: 09/133,518

(22) Filed: Aug. 13, 1998

(51) Int. Cl. H04R 25/00

(52) U.S. Cl. 381/165

(57) ABSTRACT

An audio system for portable computers utilizes spaces typically dedicated, at least in part, to cooling the system. An embodiment is shown in which a speaker is installed at the intake of a centrifugal blower and directs sound through the incoming air. A housing is built to channel the intake air, as well as the outgoing air, over a CPU and across a heat sink.

### CROSS-REFERENCE TO RELATED APPLICATIONS

Not applicable.

### BACKGROUND OF THE INVENTION

1. Field of the Invention

The invention disclosed broadly relates to speaker systems for electronic devices, and more particularly relates to speaker chambers having a dual use as part of a cooling system in electronic devices.

2. Description of the Related Art

Two additional U.S. Patent Applications dealing with related technology have been filed on even date herewith. Both applications have common inventors and a common assignee with the present application. The first application is entitled “Expandable Speaker Chambers” and has a docket number of AM9-97-186 (referred to hereinafter as the “Expandable Speaker Chambers Patent”). The second application is entitled “Impact-Resistant Electronic Device” and has a docket number of AM9-97-187 (referred to hereinafter as the “Impact-Resistant Electronic Device Patent”).

Portable electronic devices abound in today's markets. Such devices include portable games, laptop computers, personal organizers, Global Positioning System (“GPS”) receivers, and myriad other devices. These devices have become portable, and others will follow this trend, in large part because of the advances in technology that have allowed the devices to shrink in size and weight. Circuitry, hard disk storage, screens, speakers, and many other components have all been reduced in size. Improving technology also enables these components to operate on less power, which allows the power supplies and cooling mechanisms to be reduced in size and weight.

One disadvantage of shrinking the components has been a reduction in the quality of the audio.

For many devices, this is not important because their communication with the user is primarily visual.

However, many devices and applications do rely on audio for communication with, or entertainment of, the user. Additionally, many other portable devices and applications would be forthcoming if better audio were available. A common application which could utilize better audio is a workstation for accessing the World Wide Web (“WWW”), and the variety of multi-media content which it provides, including music and sound effects. Other examples include many of today's multi-media games for which sound quality is of paramount importance.

The poor sound quality is due to two primary factors. The first is the decreased speaker size. This factor makes it difficult to produce quality sound over a large frequency range, particularly at lower frequencies. The decreased speaker size also makes it difficult to produce loud sounds. The second is the decreased size of the speaker box, or speaker chamber. This also makes it difficult to produce quality sounds, particularly at low frequencies.

Several solutions have been proposed and developed. One solution involves interfacing to non-portable audio equipment and speakers. This is common in many conference rooms or classrooms which are designed for presentations and which have high quality audio systems already installed. The user is able to connect a portable computer and run a presentation with a laptop that uses the external audio system. This is also common for games and other entertainment systems that use a television set for the audio.

These are only partial solutions, however, because the user is limited in the number of places where he can use the device. In the context of a laptop being used to give a presentation, the user is limited to giving presentations in facilities which have high quality audio systems. The user is also faced with the many problems associated with interfacing to these systems and having compatible software and hardware, including connectors.

Another solution that allows the portable computer user to have high quality audio is for the user to bring along portable audio equipment. U.S. Pat. Nos. 5,082,084 and 5,550,921 show two such portable audio systems. Portable audio systems, however, are typically bulky and heavy. Additionally, they are not integrated into the portable computer or other device, and therefore make transportation and setup more difficult.

Another solution is to integrate better audio systems into the existing portable computers or other devices. U.S. Pat. Nos. 5,610,992 and 5,668,882 utilize the existing space in the portable electronic devices to produce higher quality sound. There are limits, however, to what can be done with the existing space.

Accordingly, there is a need for a speaker chamber and for audio systems which overcome these problems.

### SUMMARY OF THE INVENTION

Briefly, a combination audio system and cooling system comprises a mechanism for cooling, a mechanism for guiding sound, and a mechanism for producing sound. The mechanism for cooling is coupled to the mechanism for producing sound. The mechanism for guiding sound is also coupled to the mechanism for producing sound. The combination system is for use in an electronic device which comprises an exterior structure.

### BRIEF DESCRIPTION OF THE DRAWINGS

FIG. 1 shows two views of a centrifugal blower and two additional impellers, according to the prior art.

FIG. 2 shows one of the impellers of FIG. 1 with a speaker installed according to the present invention.

FIG. 3 shows a housing for the impeller-speaker combination of FIG. 2.

FIG. 4 shows the housing of FIG. 3 being used as a heat sink.

FIG. 5 shows the positioning of a dividing shelf according to the present invention.

FIG. 6 shows the attachment of an airguide to the impeller of FIG. 2.

FIG. 7 shows the orientation of the impeller-airguide combination of FIG. 6, inside of the housing of FIG. 3, according to the present invention.

### DETAILED DESCRIPTION OF AN EMBODIMENT

The present invention proposes another solution which uses the existing space of electronic devices for multiple purposes. In particular, because every electronic device must provide cooling, it is proposed to use these cooling spaces for speaker chambers. Cooling, or heat transfer, can be achieved with three principal methods: conduction, convection, or radiation. The present invention can be applied to all three.

The preferred embodiment, however, is concerned with spaces used for convection cooling. Convection is “the process of heat transfer caused by movement of molecules from cool regions to warmer regions of lower density.” (The Collins Dictionary and Thesaurus, 1990.) In an electronic device, this is most often achieved by using fans to blow the air molecules. Anytime that a fan is used there will be a space from which the intake air comes, and a space to which the outflow air goes. These spaces can potentially be used as speaker chambers. The preferred embodiment proposes placing a speaker in the inlet opening of a centrifugal blower and designing the housing that channels the air such that it can also serve as an effective speaker chamber.

The fact that the air is moving through these spaces could, theoretically, present an obstacle to the propagation of sound waves through the space. However, the speed with which the air moves is extremely slow compared to the speed of sound in air, so the effect is negligible.

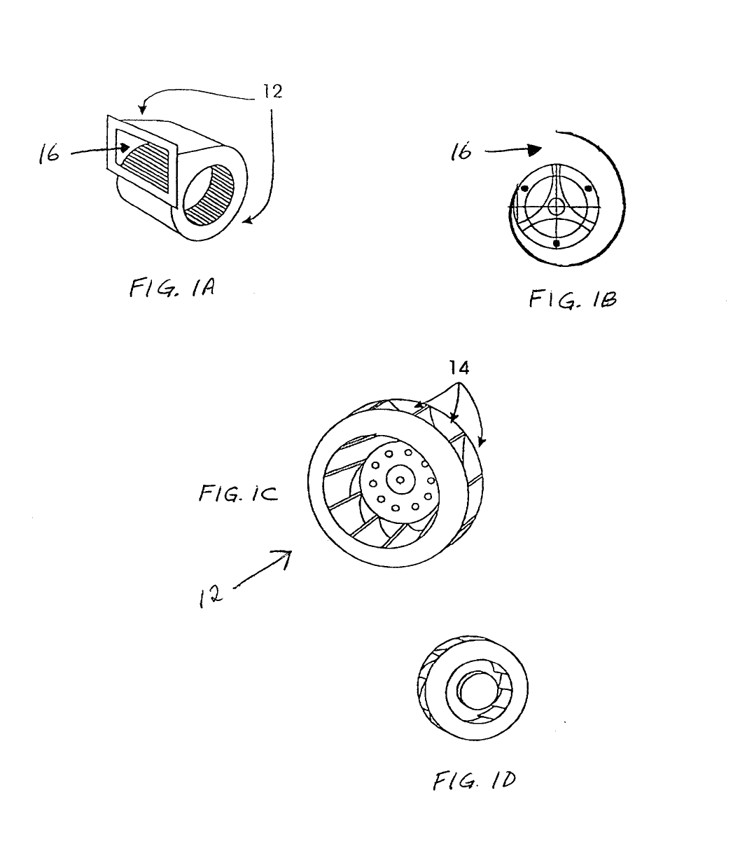

The preferred embodiment is designed for systems that use a centrifugal blower as a cooling 15—device. These devices are also known as impeller fans, barrel fans, and squirrel cage fans. FIGS. 1A and 1B show a centrifugal blower, and FIGS. 1C and 1D show alternate impellers that can be used in similar devices. The intake air comes from the openings 12 along the center axis of the impeller, and the outflow air comes from the openings 14 along the circumference of the impeller. FIGS. 1A and 1B show the outflow air being channeled into a common opening 16.

Centrifugal fans may be dual inlet as in FIGS. 1A and 1B, or single inlet as in FIGS. 1C and 1D.

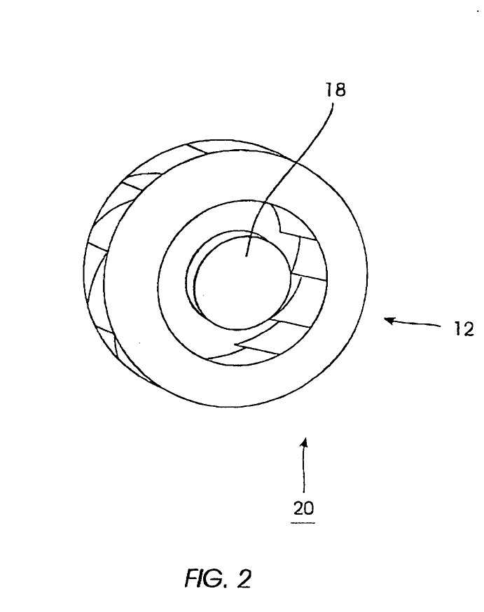

The preferred embodiment uses a single inlet fan, as shown in FIG. 2. A speaker 18 is placed in the center of the inlet opening 12. The center is typically either left empty or is occupied by a motor, bearing, or some other part of the blower. Placing the speaker 18 in the middle of the inlet opening 12 allows the sound to be projected through the incoming air stream. This is advantageous because the sound would be broken up if it were projected through the impeller, or fan. Alternate embodiments, however, may place the speaker such that it projects the sound through the outgoing air stream.

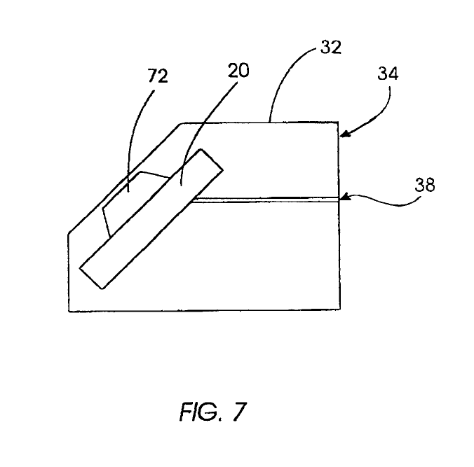

As mentioned above, the center of the impeller 20 may contain the rotating mechanism. In the preferred embodiment, the center would contain a magnet and armatures to drive the shaft, to which the impeller 20 is connected. The apparatus, therefore, already contains the necessary bearing so that the magnet does not spin along with the armatures. The speaker can easily be connected to the magnet and other parts which are not spinning. Alternatively, FIG. 7 shows an embodiment in which the motor 72 is affixed to the back of the impeller 20. In that embodiment, the speaker has ample room to be mounted inside the impeller 20. However, a bearing or other means will need to be utilized to disengage the speaker from the impeller 20 so that the speaker does not spin. It is of course possible to affix the speaker 18 to the housing 32 itself, and not directly to the impeller 20.

As is commonly known, the movement of the speaker produces back pressure as well as forward pressure. The sound waves from the back pressure need to be dealt with so that they do not distort the sound from the forward pressure. Two problems are possible. The first is that the sound waves from the back pressure could travel through the impeller and be broken up by the impeller. The second is that they could reflect off of the back of the inlet opening 12 and destructively interfere with the forward pressure sound waves.

The preferred embodiment employs a damping material such as fiberglass for the back of the inlet opening behind the speaker. It is commonly known that sound is damped by impedance mismatches experienced across boundaries between high density materials and low density materials.

Fiberglass achieves its damping quality from the boundaries between glass and air. Fiberglass can also address the second problem, that of reflections, if it has a rough surface. A rough surface will randomize the angles of reflection and thereby prevent the reflected sound waves from destructively interfering with the forward pressure sound waves. Alternate materials, such as rough aluminum, are effective at randomizing the reflections but do not dampen the sound waves.

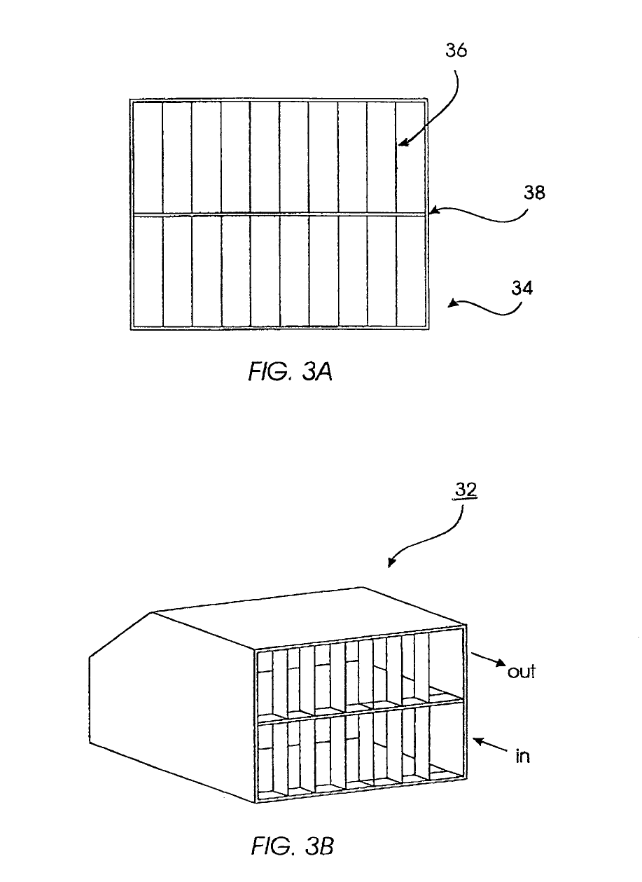

The centrifugal blower and the speaker can be housed in a variety of ways. The preferred embodiment 32 is shown in FIG. 3B. FIG. 3A shows a frontal view of the face 34 of the housing 32.

As will be explained later, the centrifugal blower is located in the rear of the housing 32 such that the intake air comes in along the bottom of the housing 32 and the outflow air exits along the top.

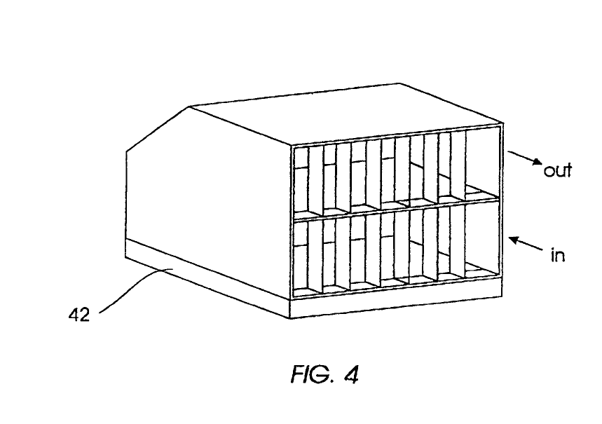

As shown in FIG. 4, the housing 32 is intended to sit on top of a heat producing device 42. A typical heat producing device 42 is a central processing unit (“CPU”) or other integrated circuit (“IC”). The IC may be assembled using flip-chip, plastic molded, or another type of assembly technology. Alternately, the heat producing device 42 may be a group of ICs, an entire printed circuit board (“PCB”), or some other type of device(s). Thus installed on top of heat producing device 42, the bottom surface of the housing 32 wicks heat from the heat producing device 42. The heat fins 36 are placed directly in the line of both the incoming air and the outgoing air, so as to further maximize cooling. While vertical fins 36 are shown, another orientation, as well as size and shape, could be used.

In certain applications, it may be desirable to design the housing to maximize performance of the housing 32 as a sound chamber for the speaker 18. Alternate embodiments may use a housing 32 that is shaped like a horn for amplification and direction. Additionally, a backplane or other device may be added behind the speaker 18 to reflect the back pressure sound waves so that they constructively interfere with the forward pressure sound waves and are directed into the incoming air stream.

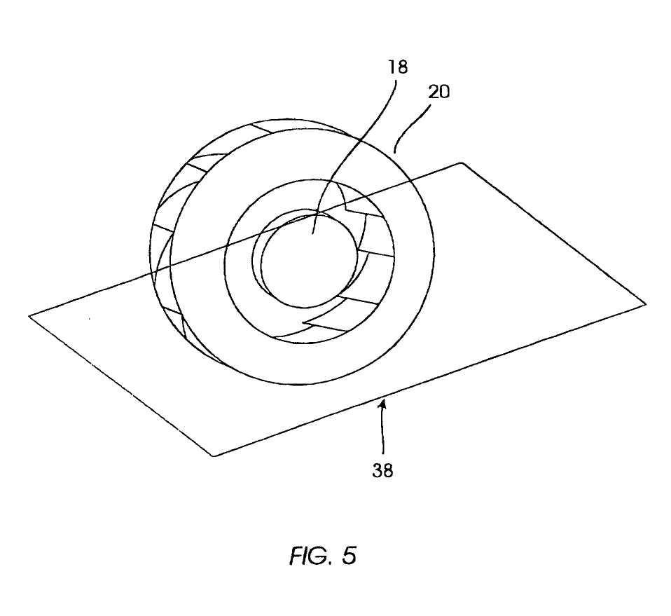

It is also desirable to isolate the incoming air from the outgoing air. The first step in achieving such a separation is the use of a dividing shelf 38. As shown in FIG. 5, the dividing shelf 38 intersects the impeller 20 just above the speaker 18. This allows the sound to be projected through the incoming air, which is below the dividing shelf 38.

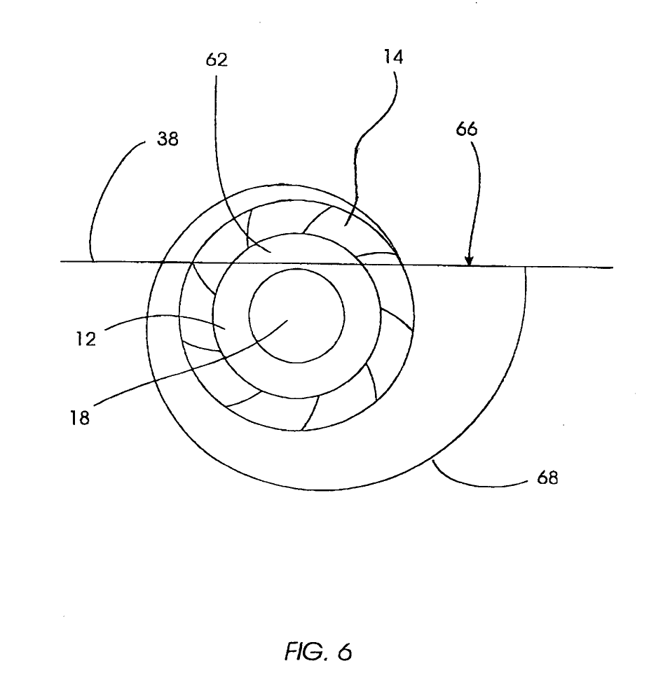

The second step in achieving separation is the use of an airguide 68, as shown in FIG. 6. The airguide channels, or guides, the outgoing air from each of the openings 14 along the circumference of the impeller 20 so that all of the outgoing air that is contained in the airguide 68 exits through its open end 66. The preferred embodiment channels all of the outgoing air into the airguide 68, but alternate embodiments may leave the openings 14 of the impeller 20 uncovered if they are above the dividing shelf 38.

The third step in achieving separation between the incoming air and the outgoing air is to cover that portion 62 of the opening 12 through which the incoming air enters the impeller 20. If this region 62 is not covered, then some of the outgoing air will be circulated back through the impeller 20. This will result in a lower volume of outgoing air and incoming air, per unit time, passing across the fins 36 of the front face 34 as well as the other surfaces of the housing 32.

The last step in achieving separation is to extend the dividing shelf 38 past the impeller 20 toward the back of the housing 32. In essence, the dividing shelf 38 should have a cutout that fits the impeller 20 and the airguide 68. In this way, the only way to get from the incoming air stream to the outgoing air stream is to go through the impeller 20. Many alternate embodiments are possible to seal off the two streams. It is also possible to add additional elements, such as a 90 degree guide to attach to the open end 66 of the airguide 68 in order to channel the outgoing air in the proper direction.

As FIG. 5 indicates, the dividing shelf 38 intersects the impeller 20 above the centerline of the impeller 20. As FIG. 6 indicates, the intersection point is even further above the centerline of the impeller-airguide (20-68) combination. In many embodiments it will desirable to keep the speed of both the incoming and outgoing air substantially the same. This can be achieved by making the openings in the face 34 of the housing 32 (see FIG. 3), for the incoming and outgoing air, the same size. This is not referring to the space between the individual fins 36, but to the total area above (and below) the dividing shelf.

This can be achieved in a variety of ways. Referring to FIG. 7, in the preferred embodiment the impeller 20 is installed at an angle, thus lowering the dividing shelf 38. An alternate embodiment may also tilt the dividing shelf 38 downward toward the front face 34 of the housing 32. Yet another alternate embodiment may simply increase the height of the housing 32.

The above discussion focused principally on the preferred embodiment. Other, quite different, embodiments are also possible. These other embodiments need not, as mentioned earlier, be restricted to use with convective cooling systems. For example, heat pipes typically contain a shroud or housing that curves around the pipe and is used as a heat fin. The space contained within the housing can potentially be used as a speaker chamber. The cooling provided by this heat fin is largely conductive, although some convection will also unavoidably occur.

As this heat pipe embodiment suggests, the housing need not be fully enclosed, it need only form a space that can be used as a speaker chamber. The interior of an electronic device can suffice, as can any subset of the interior that is partially or completely closed off. Devices within the electronic device can also be used to help shape the space that will be used as the speaker chamber, or merely to help guide the sound waves themselves. It is desirable to design the space, or the housing, for optimal audio, however this is not essential. It is sufficient that there be space that can be used for the audio system.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A combination audio system and cooling system, for use in an electronic device which comprises an exterior structure, the combination system comprising:
means for cooling the electronic device;
means for producing sound, wherein the means for producing sound is coupled to the means for cooling the electronic device; and
means for guiding sound, wherein the means for guiding sound is coupled to the means for producing sound.

2. The combination system of claim 1, wherein the means for cooling the electronic device comprises the means for guiding sound.

3. The combination system of claim 1, wherein:
the means for cooling the electronic device comprises a heat pipe;
the means for producing sound comprises a speaker;
the means for guiding sound comprises a housing which is attached to and wraps around, the heat pipe, wherein the speaker is coupled to the housing.

4. The combination system of claim 1, wherein:
the means for cooling comprises a means for moving air; and
the means for guiding sound comprises a means for guiding the moving air, which is coupled to the means for moving the air.

5. The combination system of claim 4, wherein the means for moving air comprises the means for guiding the moving air.

6. The combination system of claim 4, wherein:
the means for moving the air comprises an electric centrifugal blower;
the means for guiding the moving air comprises a housing that supports and encloses the blower, the housing comprising two chambers, a first chamber for guiding incoming air, and a second chamber for guiding outgoing air; and
the means for producing sound waves comprises a speaker, the speaker being coupled to the first chamber such that any sound waves produced by the speaker will be guided by the first chamber through the incoming air, if any.

7. The combination system of claim 4, wherein the means for guiding the moving air comprises the exterior structure of the electronic device.

8. An audio system, for use with an electronic device, comprising:
a cooling system, comprising a chamber, wherein the cooling system utilizes the chamber, at least in part, for convective cooling; and
a speaker, wherein the speaker is physically coupled to the chamber.

9. The audio system of claim 8, wherein:
the cooling system further comprises:
a centrifugal blower comprising an interior cavity, the centrifugal blower being physically coupled to the chamber; and
a heat sink, forming part of the exterior surface of the chamber; and
the speaker is coupled to the interior cavity of the centrifugal blower; and
the chamber further comprises a front face through which the incoming and outgoing air pass, the front face comprising fins that serve as additional heat sinks.
